(19) United States
(12) Patent Application Publication
(10) Pub. No.: US 2006/0217105 A1
(43) Pub. Date: Sep. 28, 2006

(54) Method and system to provide location and multimedia data using a wireless device

(75) Inventors: Sampath Kumar P S, San Diego, CA (US); Srilakshmi Madala, San Diego, CA (US); Umesh Uppili, Mumbai (IN)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Communications, Inc.

(21) Appl. No.: 11/089,960

(22) Filed: Mar. 25, 2005

(51) Int. Cl. H04M 11/04

(52) U.S. Cl. 455/404.1

(57) ABSTRACT

Apparatuses and methods for a wireless device to provide location data of the wireless device and multimedia data in an emergency situation. The wireless device may initiate a communication link to an emergency response entity (e.g., service center or emergency service provider), and communicate with the emergency response entity over the communication link to provide location data of the wireless device and multimedia data associated therewith. The location data and the multimedia data, including audio, video, and textual information, may be transmitted to the emergency entity in a single message. In some embodiments, the initiation of the communication link may be accomplished by a single user entry to the wireless device.

### BACKGROUND

The present disclosure relates generally to wireless devices, and more particularly to a method and apparatus for providing pertinent information including location, multimedia data, and other information regarding an emergency situation using the wireless device.

Wireless devices are in widespread use. Modern wireless devices may include a number of components, functionalities, and/or technologies such as, for example, a memory, a controller, a speaker, a microphone, a graphics display, and a camera. The various components, functionalities, and technologies of the wireless device may operate to provide a device having interactive multimedia capabilities. Wireless devices that utilize the multimedia capabilities thereof may provide various services and features.

A popular reason provided for owning and using a wireless device such as, for example, a mobile phone is the convenience and availability provided in cases of an emergency to contact emergency rescue services and personnel. Users of mobile phones often cite the potential need to phone for assistance should they find themselves in a compromised or emergency situation as a major motivation for obtaining and maintaining a wireless device and its associated service plan.

However, in certain situations a wireless device user may not be able to fully, accurately, or adequately communicate the location, extent, and other specifics regarding an emergency situation. Thus, there exists a need to provide an efficient device, system, method, and means for communicating relevant information in an emergency situation using a wireless device.

### SUMMARY

In some embodiments hereof, an apparatus is provided. The apparatus may include a wireless device such as, for example, a cellular telephone. The apparatus may include a processor; a radio frequency (RF) transmitter/receiver, operatively coupled to the processor, for receiving and transmitting information; a speaker operatively coupled to the processor; a microphone operatively coupled to the processor; and a memory operatively coupled to the processor and storing software to control the processor. The software may include executable program instructions which, when executed, control the processor to receive a single user input to the wireless device, activate a first mode of operation of the wireless device, in response to the received single user input, and automatically transmitting, in response to the activating, a multimedia message service (MMS) message including location data indicative of a location of the wireless device and multimedia data captured by the wireless device from a local vicinity of the location of the wireless device to an emergency response entity.

These and further aspects hereof may be more clearly understood by reference to the following detailed description, the appended claims, and to the several drawings attached herein.

### BRIEF DESCRIPTION OF THE DRAWINGS

The accompanying drawings, which are incorporated in and form a part of the specification, illustrate some embodiments of the present invention, and together with the descriptions serve to explain the principles therein.

FIG. 1 is an exemplary illustration of an embodiment of an apparatus according to some embodiments hereof;

FIG. 2 is a block diagram of some potential components for the apparatus of FIG. 1, in accordance with some embodiments hereof;

FIG. 3 is a flow diagram of an exemplary method in accordance with some embodiments hereof.

FIG. 4 is an exemplary system in accordance with some embodiments herein;

### DETAILED DESCRIPTION

According to some embodiments, a wireless device provides an apparatus and methods for automatically transmitting a MMS (Multimedia Message Service) message including location data indicative of a location of the wireless device and multimedia data captured by the wireless device from a local vicinity of the location of the wireless device to an emergency contact entity. The MMS message may be transmitted in response to a single user input or action to the wireless device. For example, the wireless device may be activated by actuation of a softkey to enter into a mode of operation wherein a MMS message is automatically sent to an emergency contact entity to notify the emergency entity of a location of the wireless device and a number of parameters in the vicinity of the wireless device. The parameters in the vicinity of the wireless device may relate to an emergency situation and may include, for example, a sound, a motion, an image, video data, and/or a combination thereof in the local vicinity of the wireless device. The particular parameter transmitted may be selectively monitored for detection, capture, and/or transmission by the wireless device.

Some or all of these features may improve a wireless device user's ability to use the wireless device to report and notify an emergency contact of an emergency situation in a vicinity of a wireless device.

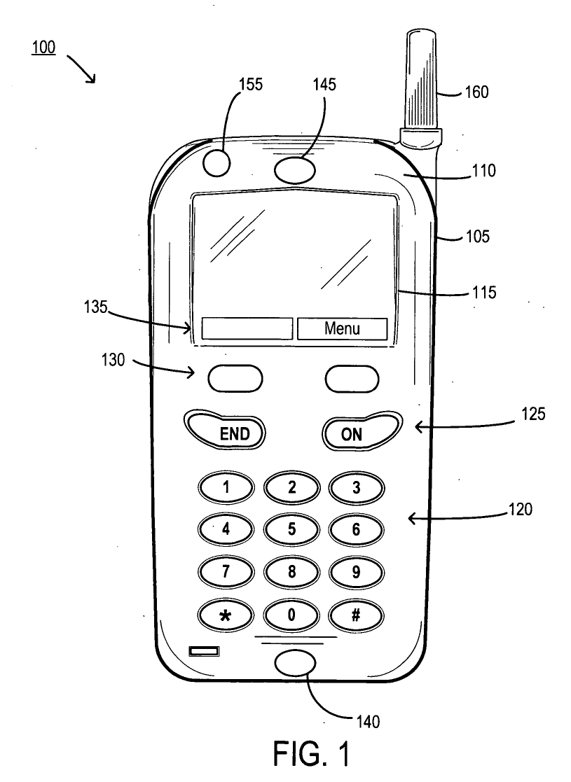

Referring to FIG. 1, there is shown an exemplary illustration of an embodiment of an apparatus, a wireless device, according to some embodiments hereof. The wireless device is generally represented by numeral 100. Wireless device 100 may include various components, functionalities, and technologies to provide a variety of features and capabilities, including multimedia capabilities. Wireless device 100 may include, as an example, a cellular telephone, a wireless telephone, a personal digital assistant (PDA), a push-to-talk (PTT) walkie talkie, a handheld personal computer (PC), a combination of these and other devices, and any other device that may include the same, like or other functionality in accordance with the present disclosure.

Wireless device 100 may be completely or largely conventional in terms of its physical components with regards to a cellular telephone. Wireless device 100 may be programmed to perform certain functions (e.g., to operate in various modes and execute various actions) in accordance with aspects of the present disclosure.

Wireless device 100 includes a housing 105, including a front housing 110 that may be shaped and sized to fit in a user's hand. Other components of wireless device 100, described in greater detail below, are mounted on, to, or within housing 105.

Wireless device 100 includes a display 115 that is mounted to front housing 110. Wireless device 100 also includes a numeric keypad 120. Keypad 120 may be mounted on, in, or through front housing 110 such that keypad 120 is accessible to the user. Wireless device 100 may include a number of certain, fixed function keys 125. Fixed function keys 125 may be associated with a predetermined function and/or feature of wireless device 100. For example, fixed function keys 125 may operate to initiate and terminate certain features and functions such as power. Functions keys 125 may be labeled, as shown, as ON and END.

Wireless device 100 may have a number of keys commonly referred to as “soft” function keys 130. Softkeys are accessible from front housing 110. A function associated with softkeys 130 will vary in accordance with a function label 135 displayed on display 115.

Front housing 110 may include a microphone 140 for receiving an audio signal and a speaker 145 for broadcasting an audio signal. Wireless device 100 may include a camera 155 for receiving a visual signal. In some embodiments, camera 155 may include functionality for receiving infrared (IR) signals.

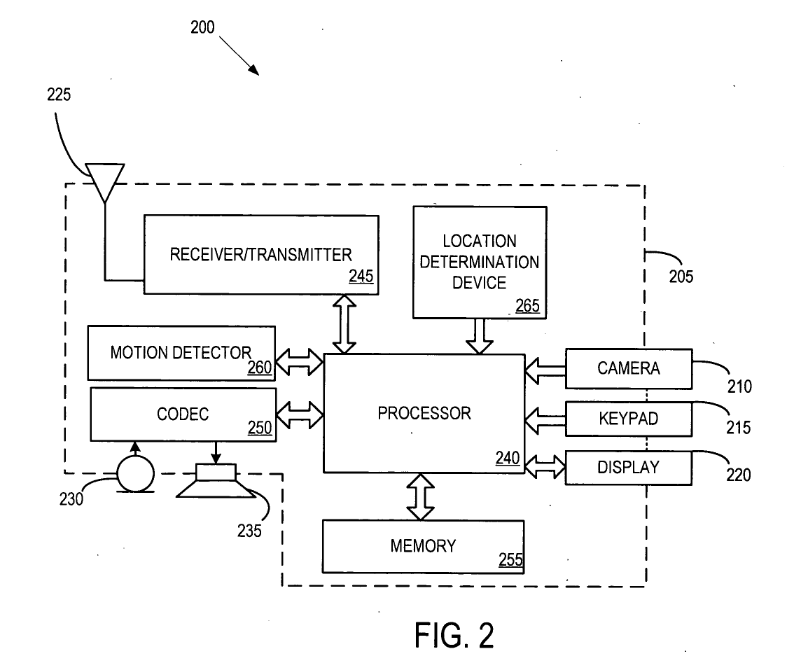

Wireless device 100 may include a motion detector 260 (shown in FIG. 2) for receiving a signal indicative or representative of a motion or movement in the vicinity of the wireless device. Motion detector 260 may be included as part of another component of wireless device 100 such as, for example, camera 210.

Housing 105 may include these and/or other keys, components, and the like on a front housing thereof and other portions of housing 105, including a back, a top, and sides of housing 105 that are not shown, so as to simplify the exemplary illustration of FIG. 1. Further, wireless device 100 may include keys, components, and the like (not shown for purposes related to clarity of the drawing) that are concealed from view by, for example, portions of housing 105 that are selectively moveable to conceal these other keys, components, and the like.

An antenna 160 extends from the top of housing 105. Antenna 160 is operatively coupled to a receiver/transmitter and aids in the transmission and reception of radio frequency (RF) signals transmitted and received by the receiver/transmitter. Antenna 160 may or may not be extendable to a length other than that illustrated in FIG. 1. Antenna 160 may, in some embodiments, be housed entirely within housing 105.

FIG. 2 is an exemplary block diagram of some potential components for the apparatus of FIG. 1, in accordance with some embodiments of the present disclosure.

As illustrated in FIG. 2, wireless device 200 includes a processor 240. Processor 240 may be a microprocessor, microcontroller and/or digital signal processor (DSP) or other control circuit provided in a wireless device. Also included in wireless device 200 is a memory component 255. Memory 255 may include one or more of ROM (read only memory), RAM (random access memory, e.g., static RAM, dynamic, etc.), and flash memory. Processor 240 is operatively connected to (i.e., in data communication with) memory 255. Memory 255 may store software code, instructions, including programs that control operation of the processor 245.

Some of the software of wireless device 200 may be provided in accordance with the present disclosure to cause processor 245 to perform functions further described below.

A codec (coder/decoder) 250 may be included in wireless device 200. Codec 250 is, operatively connected, in data communication with the processor 245. A receiver/transmitter 245 is operatively coupled to codec 85. Receiver/transmitter 245 is operatively coupled to antenna 225. Receiver/transmitter 245 may comprise a combination of two or more different receive/transmit modules (not separately shown) that operate in accordance with mutually different radio communication protocols to provide various services for wireless device 200. For example, receiver/transmitter 245 may operate in accordance with one radio communication protocol to provide conventional cellular two-way service for wireless device 200, and may operate in accordance with another radio communication protocol to provide PTT service for wireless device 200. The wireless device may operate in accordance with a number of communication standards, such as, for example, GPRS (General Packet Radio Service), EDGE (Enhanced Data GSM Environment), UMTS (Universal Mobile Telephone Service).

Microphone 230 is operatively coupled to codec 250 to provide audio (e.g., voice) input signals to codec 250. A speaker 235 is operatively coupled to codec 250. Speaker 235 is driven by codec 250 to provide audible output therefrom.

Keypad 215 and camera 210 are operatively coupled to processor 245. Display 220 is operatively coupled to processor 245 to provide a display area for graphical output. The graphical output may include text and video (e.g., still and motion) stored in memory 80 or received by receiver/transmitter 90 (e.g., streaming video). Display 220 may form, in part, a graphical user interface of wireless device 200. In some embodiments hereof, display 220 may include a touch screen to receive input from a user of wireless device 200.

It should be understood that the block diagram representation of wireless device 200 shown in FIG. 2 is simplified in a number of ways. For example, all power, and power management components of wireless device 200 are omitted from the drawing.

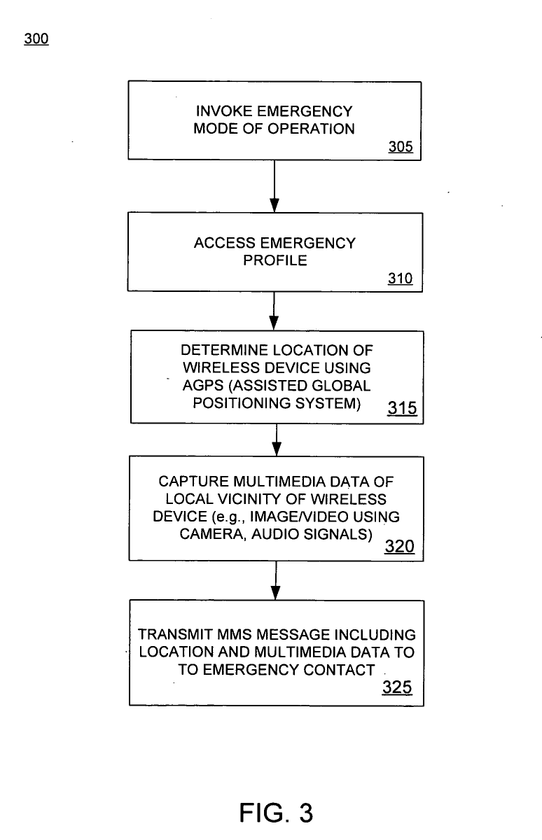

FIG. 3 is an exemplary flow diagram that illustrates a process 300 that may be performed by wireless device in accordance with some aspects of the present disclosure. Process 300 relates to transmitting, in an emergency situation, a MMS message including location information and multimedia data of a local vicinity of the wireless device to an emergency contact to notify the emergency contact of the emergency situation. A mode of operation that encompasses the notification of the emergency contact may represent one of a number of functions and/or modes of operation provided by the wireless device (e.g., 100). In some embodiments, the emergency mode(s) of operation for the wireless device disclosed herein is but one of a number of modes of operation for wireless device. The wireless device may include a mobile handset, a PDA, a handheld computer, a walkie-talkie, a portable multimedia player, and other devices capable of performing multiple functions.

It will also be appreciated that the methods of operation disclosed herein are not limited by any title or descriptor associated therewith, but in general are associated with the operations, steps, process, functions, etc. used and suggested in the description of the methods.

Process 300 may be implemented by a software program stored in one or more of memory devices resident in the wireless device, such as, for example, memory 255 shown in wireless device 200 of FIG. 2. In some embodiments, memory 255 may be removably received in the wireless device. For example, the memory including a program, instruction, or code for implementing method 300 may be a SIM (Subscriber Identification Module), USIM (Universal Subscriber Identification Module), or any other resident memory, removable memory, memory store accessible to the wireless device, including a proprietary memory format.

At operation 305, the wireless device (e.g., 100, 200) may be activated to begin an emergency mode of operation of the wireless device. A user may invoke the emergency mode of operation by, for example, actuating a key on keypad 120, a softkey 130, or another (not shown) button, key, or user input device located on the wireless device. It will be appreciated that the other button, key, or user input device located on the wireless device may be located on the front, back, side, or other location of the wireless device.

It will also be appreciated that the methods of operation disclosed herein are not limited by any title or descriptor associated therewith, but in general are associated with the operations, steps, process, functions, etc. used and suggested in the description of the methods.

In some embodiments, a single user input to the wireless device 100, 200 activates the emergency mode of operation. For example, a single key press may launch wireless device 100 into the emergency mode of operation. In some embodiments, the single user input to activate the emergency mode of operation is received by a button, key, or other user input device solely dedicated to activating the emergency mode of operation.

In some embodiments, the single user input to activate the emergency mode of operation is received by a button, key, or other user input device having at least a dual purpose. For example, pressing the number “1” on keypad 120 may be received as entry of the number 1 when pressed for about 1 second or less (i.e., a short key press) whereas pressing the number “1” on keypad 120 may be received as activating the emergency mode of operation when pressed for about 3 seconds or longer (i.e., a long key press).

In some embodiments, a dedicated key, button, or other user input device may be actuated using a long key press and a short key press, each type of key press initiating different responses. For example, a long key press of the key, button, or other user input device for more than about 3 seconds may place the wireless device immediately into the emergency mode of operation. In some embodiments, a long key press of the key, button, or other user input device for less than about 1 second or less may place the wireless device into the emergency mode of operation after a relatively short delay if no user attempt is made to avoid activating the emergency mode of operation. For example, following a short key press of a dedicated emergency mode activation hardkey or appropriately mapped softkey, wireless device 100, 200 may enter the emergency mode of operation unless a user input to abort entering the emergency mode is received relatively soon after the long key press. In some instances, unless a user input to abort entering the emergency mode of operation is received within about 10 seconds after the long key press, then wireless device 100, 200 will activate the emergency mode of operation.

At operation 310, an emergency profile is accessed by the wireless device. The emergency profile may be stored in memory 255. As mentioned above, memory 255 may be RAM, ROM, a hard drive based storage device, removably received by the wireless device (e.g., 100, 200) For example, the emergency profile may be stored on a SIM card that is removably received and accessed by the wireless device. In some embodiments, the emergency profile may be stored on a device that is external yet accessible by the wireless device such as, for example, a server, a dedicated storage device, a computing device having storage capability, etc. The wireless device may access the emergency profile using any of a number of communication techniques and protocols that may be compatible with the wireless device.

In some embodiments herein, the emergency profile includes information that may be associated with a user of the wireless device 100, 200. For example, the emergency profile may include information associated with the user of the wireless device such as the user's: name, home address, home telephone number, work address, work address, emergency contact, social security or other identification number/information (e.g., passport information), blood type, medical conditions, allergies, medical insurance information (e.g., insurance plan, plan number, contact(s), deductible, etc.), automobile insurance information (e.g., insurance plan, plan number, contact(s), deductible, etc.), home insurance information (e.g., insurance plan, plan number, contact(s), deductible, etc.), etc.

In some embodiments, the emergency profile information may be categorized or include information related to particular types of situations, persons, users, etc. For example, the emergency profile may include a number to contact in the instance of a medical emergency and yet another number to contact in the instance of an automobile emergency. That is, the emergency profile may be customized for a user, a type of service provided with the wireless device, etc.

In some embodiments, the emergency profile is embodied on a memory device removably received by the wireless device 100, 200 such as a SIM card. Thus, the emergency profile accessed at operation 310 may be customized for the particular user of the wireless device inasmuch as the user's SIM card includes emergency profile information specific to the user. As will be seen upon further discussion, the emergency profile may be used to provide pertinent and personal information associated with a user of the wireless device to an emergency contact. The emergency contact may include, inter alia, police, firemen, emergency medical technicians, next of kin, a parent, a spouse, a child, or any other person or entity identified as someone to contact in an emergency situation.

At operation 315, a location of the wireless device is determined. The determined location is preferably precise and detailed enough to, for example, inform emergency personnel of the location of the wireless device (e.g., 100). In some embodiments, the wireless device will employ a location determination technique that may be referred to as AGPS (Assisted Global Position System). AGPS may be employed to provide an accurate method of location determination that requires relatively low resources (e.g., hardware and/or software) from the wireless device. For example, an AGPS location determination technique may make use of a GPS functionality that is integrated or associated with the wireless device as well as an assistance server external to the wireless device.

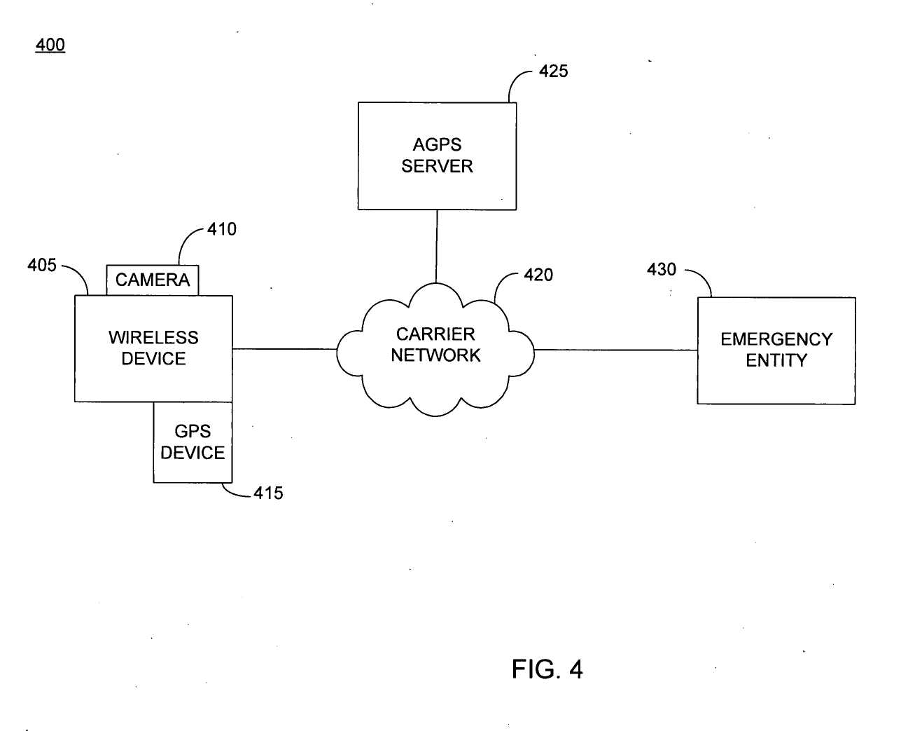

In some embodiments herein, as depicted in exemplary FIG. 4, the hardware infrastructure of a wireless device 405 may be used in conjunction with a source of information external to the wireless device in an AGPS technique to determine the location of the wireless device. The external source of information may be provided by or from an assistance server and a reference network of location related data. The assistance sever may be an AGPS server 425 and the reference network may be a cellular communications network 420. AGPS server 425 may access information from the cellular communications network 430. AGPS server may also provide processing resources that are, for example, more powerful, faster, and in addition to the processing resources of wireless device 405. AGPS may relieve wireless device 405 of at least some of the location determination processing duties of the methods disclosed herein. AGPS server 425 may communicate with a GPS device 415 via a wireless communication link (i.e., cellular network 420). AGPS server 425 and cellular network 420 may provide GPS device 415 with an initial approximate location of wireless device 405 and other information such as decoded satellite ephemeris and timing information. GPS device 415 may use such information to quickly determine an accurate position of wireless device 405. The resources of AGPS server 405 and cellular network 420 may be used to assist GPS device 415 and wireless device 405 in determining the location thereof.

In some embodiments, wireless device 405 may communicate with AGPS server 425 or other devices that may provide assistance to wireless device 405 to facilitate determining a location thereof. For example, wireless device 405 may communication with a server, computer, or other device via, for example, an infrared link, Bluetooth™, via a wireless LAN, and other wireless communication links and protocols. Accordingly, wireless device 405 may include functionality for communicating with via infrared, Bluetooth, via a wireless LAN, and other wireless communication links and protocols.

In some embodiments, GPS device 415 may not be connected directly to wireless device 405. Instead, GPS device 415 may communicate with wireless device 405 via a wired, or preferably, wireless communication link of any now known and future known type and protocol.

Referring to operation 320 of FIG. 3, various functionalities of wireless device 100, 200 are used to capture multimedia data in a vicinity of the wireless device. For example, microphone 140, 230 may be used to capture audio signals, camera 155, 210 may be used to capture image and video data, and keypad 120, 215 may be used to capture alpha-numeric data input to the wireless device.

In some embodiments, other capture devices (not shown) and/or functionality may be included in the wireless device and used in operation 320. For example, biometric input devices or sensors may be included and associated with the wireless device that may be used to gather or capture information in the vicinity of the wireless device. As an example, the wireless device may include a temperature sensor, a pressure sensor, an altimeter, a pulse monitor, a heart monitor, etc.

It will be appreciated that the multimedia data captured by the wireless device may include any number of combinations of the various types of data captured thereby. For example, the wireless device may or may not capture audio, video, images, text, and other types of data, in isolation or in combination, at operation 320.

At operation 325, a MMS message including the determined location of the wireless device and the multimedia data is transmitted. In some embodiments, the MMS message is transmitted to a designated emergency entity (FIG. 4, 430). The emergency entity may be any one or a number of people, or one or a number of other entities such as, for example, a police station, a fire station, an ambulance service, and other rescue or emergency response personnel. The emergency entity may also be an individual or entity specified for contacting in the event the emergency mode of operation herein is activated. The emergency contact may be a neighbor, a spouse, next of kin, a parent, a child, a religious officer, a nurse, a doctor, etc.

The emergency contact may include an email address, a telephone number, a web site, a physical (i.e., street) address or other identifying mechanism for directing the transmitted MMS message to the intended recipient thereof. In some embodiments, the MMS message is transmitted to the email address or other address capable of receiving an MMS message.

The MMS message may include image and video data as a part thereof. It will be appreciated that the multimedia data of the MMS message is included in the message itself as opposed to being attached to the body of a message, as is the case with a conventional email message. Also, it will be appreciated that the multimedia data of the MMS message of 325 is not limited to a specific length, as is the case with a SMS (Short Message Service) message.

In some embodiments herein, operation 325 may be repeated a number of times upon the activation of the emergency mode of operation at 305. That is, numerous MMS messages may be transmitted from the wireless device in response to the activation of the emergency mode of operation. For example, a MMS message including image and/or video data may be transmitted at specific intervals of time in response to activation of the emergency mode of operation. A MMS message may be transmitted after activation of the emergency mode of operation and about every 1 minute, every 3 minutes, every 5 minutes, etc. thereafter. That is, the subsequent MMS messages include newly acquired or captured video and/or image data captured of the vicinity of the wireless device.

In some embodiments, the content or combination of multimedia data included in the MMS message may vary or be specified by a user, an emergency profile, the wireless device or other controlling mechanisms. For example, in some embodiments the MMS message multimedia content may be determined or specified by a user, the emergency profile, the emergency contact, a configuration of the wireless device or the mobile network providing service for the wireless device.

It should be appreciated that by including the location of the wireless device as well as multimedia data from the local vicinity of the wireless device, the transmitted MMS message may be quite useful and/or efficient in notifying an emergency contact of the situation at the local vicinity of the wireless device. The location of the wireless device and the multimedia data, including the emergency profile information that may be provided in the MMS message, may combine to provide an efficient notification of the circumstances surrounding an emergency to an emergency contact. In some instances, the emergency contact may be able to respond to the emergency situation in an appropriate manner based on the breadth of information (e.g., audio, video, and image data) provided in the MMS message.

It should be appreciated that the flow diagram of FIG. 3 is an illustrative example according to some embodiments of the present disclosure. However, the order of the operations in FIG. 3 are not meant to place any limitations on the sequence or number of operations, steps, or processes of the present disclosure. According, the methods herein may be performed in any number of applicable steps and orders.

In some embodiments herein, other functions of the wireless device 100, 200 may operate during or as part of the emergency mode of operation disclosed herein. For example, a conventional voice call operation (both originating and receiving) may operate to place and receive calls while the wireless device is operating in an emergency mode of operation. Thus, in some embodiments, the wireless device may be in the emergency mode of operation and receive a call from an emergency contact that was earlier notified of an emergency situation by an MMS message transmitted from the wireless device. The wireless device may still be operating in the emergency mode of operation and sending MMS messages including captured photo images every 3 minutes to the emergency contact. The emergency contact may therefore phone the user at the number provide in the MMS multimedia data (e.g., wireless device number from emergency profile information) as the emergency contact is in route to the location specified in the MMS message (as determined by AGPS by the wireless device).

In some embodiments herein, wireless device 100, 200 may operate to periodically determine its location such that a preliminary location may be available upon an initial activation of the emergency mode of operation disclosed herein. In some embodiments, the wireless device may associate a time stamp with the determined location such that, for example, a last known location and associated time may be provided to an emergency contact in an instance the wireless device is not able to provided an updated determination of its location (possibly due to loss of satellite coverage).

In some embodiments, a memory accessible to a wireless device hereof and/or operations of the wireless device may be used to store at least some of the MMS messages transmitted by the wireless device. Such stored MMS messages may be beneficial in reviewing, recreating, or otherwise learning about an emergency situation associated with an emergency mode of operation for the wireless device. Achieved or stored MMS messages may be stored in a database, a folder, a server, or other data construct without limit.

In some embodiments herein, wireless device 100, 200 or a device (e.g., computer, server, etc.) that may be communicated with by the wireless device may have location information that may be used to supplement the location determination aspects herein. For example, a resident memory or external server may have latitude and longitude data and/or city and street level location information stored thereon. Such information may be used to determine a detailed and exact location for inclusion in the MMS messages herein.

In some embodiments, the methods and devices disclosed herein may operate in cooperation with 911 and Enhanced 911 (E-911) services. That is, an MMS may be automatically transmitted to an emergency entity in accordance with an applicable 911 or E-911 service in an operational service area of the wireless devise herein. The MMS 911 or E-911 service may be in addition to or in lieu of an emergency contact identified in an emergency profile.

In some embodiments, the methods disclosed herein may be embodied in executable code or instructions. For example, the code or instructions may be stored in applications, applets, modules, etc. stored in memory 255 and executed by processor 240.

While the apparatus and methods of the present disclosure have been described in detail in the foregoing embodiments, it is to be understood that the descriptions have been provided for purposes of illustration only and that other variations, both in form and detail, can be made thereupon by those skilled in the art without departing from the spirit and scope of the invention, which is defined solely by the appended claims.

What is claimed is:

1. A method of operating a wireless device, comprising:
receiving a single user input to the wireless device;
activating a first mode of operation of the wireless device, in response to the received single user input; and
automatically transmitting, in response to the activating, a multimedia message service (MMS) message including location data indicative of a location of the wireless device and multimedia data captured by the wireless device from a local vicinity of the location of the wireless device to an emergency response entity.

2. The method of claim 1, wherein the single user input is directly received at the wireless device.

3. The method of claim 1, wherein the single user input is received from a location remote from the wireless device.

4. The method of claim 1, wherein the multimedia data includes, at least, video data, image data, audio data, textual data, and any combinations thereof captured by the wireless device.

5. The method of claim 1, further comprising capturing at least one of image data and video data by a camera of the wireless device for inclusion as at least part of the multimedia data.

6. The method of claim 5, wherein the capturing is performed at predetermined time intervals.

7. The method of claim 5, wherein the capturing is performed automatically in response to the activating of the first mode of operation.

8. The method of claim 1, wherein the wireless device is a telephone.

9. A wireless device comprising:
a processor;
a radio frequency (RF) transmitter/receiver, operatively coupled to the processor, for receiving and transmitting information;
a location determination module, operatively coupled to the processor, for determining a location of the wireless device by an Assisted GPS (Global Positioning System) technique;
a speaker operatively coupled to the processor;
a microphone operatively coupled to the processor;
an camera operatively coupled to the processor; and
a memory operatively coupled to the processor and storing code to control the processor to:
activate operation of the wireless device in a first mode of operation of the wireless device, the activating is in response to a single user input to the wireless device; and
automatically transmit, in response to the activating, a multimedia message service (MMS) message including location data indicative of a location of the wireless device and multimedia data captured by the wireless device from a local vicinity of the location of the wireless device to an emergency response entity.

10. The wireless device of claim 9, wherein the activating is initiated by a direct actuation of one of a key and a soft key of the wireless device.

11. The wireless device of claim 9, wherein the single user input is received from a location remotely removed from the wireless device.

12. The wireless device of claim 9, wherein the multimedia data includes, at least, video data, image data, audio data, textual data, and any combinations thereof captured by the wireless device.

13. The wireless device of claim 9, wherein the processor is further controlled to control the camera to capture at least one of image data and video data for inclusion as at least part of the multimedia data.

14. The wireless device of claim 13, wherein the camera captures the at least one of image data and video data at predetermined time intervals.

15. The wireless device of claim 13, wherein the capture is performed automatically in response to the activating of the first mode of operation.

16. The wireless device of claim 9, further comprising a removable memory device to store at least one of, a portion of the multimedia data and a portion of the code to control the processor.

17. The wireless device of claim 9, wherein the wireless device is a telephone.
